(19) United States
(12) Patent Application Publication
(10) Pub. No.: US 2024/0162982 A1
(43) Pub. Date: May 16, 2024

(54) OPTICAL SPACE COMMUNICATION DEVICE AND OPTICAL SPACE COMMUNICATION METHOD

(71) Applicant: NIPPON TELEGRAPH AND TELEPHONE CORPORATION, Tokyo (JP)

(72) Inventors: Takeshi IMAI, Musashino-shi, Tokyo (JP); Naotaka SHIBATA, Musashino-shi, Tokyo (JP); Shin KANEKO, Musashino-shi, Tokyo (JP); Rintaro HARADA, Musashino-shi, Tokyo (JP)

(73) Assignee: NIPPON TELEGRAPH AND TELEPHONE CORPORATION, Tokyo (JP)

(21) Appl. No.: 18/284,297

(22) PCT Filed: Apr. 2, 2021
(86) PCT No.: PCT/JP2021/014373

§ 371 Date: Sep. 27, 2023

(51) Int. Cl. H04B 10/112

(52) U.S. Cl. CPC H04B 10/112

(57) ABSTRACT

According to an embodiment, an optical space communication device includes: an optical antenna configured to receive laser light emitted by multiplexing a main signal to be communicated and a control signal used to maintain or control the communication; an optical branching element configured to branch the laser light received by the optical antenna into first laser light and second laser light; a main signal extraction unit configured to extract the main signal based on the first laser light; a positional deviation detection unit configured to detect a positional deviation of the laser light based on the second laser light; and a control signal extraction unit configured to extract the control signal based on the second laser light.

### TECHNICAL FIELD

The present invention relates to an optical space communication device and an optical space communication method.

### BACKGROUND ART

In 5th generation mobile communication systems (5G) or the like, in addition to wireless communication by radio waves and wired communication by optical fibers, optical wireless communication technologies for transmitting a signal using spatial light have been examined.

In space communication in which space light is used, a transmission device modulates and multiplexes a control signal related to communication maintenance such as an instruction and a device information notification and a signal (main signal) which is a main purpose of communication in conformity with different modulation schemes. Then, the transmission device drives a laser light source (laser diode (LD)), and emits a signal obtained by modulating and multiplexing the main signal and the control signal from the optical antenna as a laser beam (laser light).

A reception device receives the laser light through an optical antenna and causes the laser light to be incident on a light reception element (avalanche photodiode (APD)) or the like via a reflection mirror or the like disposed at its rear stage. Then, the reception device separates and extracts the main signal and the control signal from an output of the APD, and demodulates the main signal and the control signal.

In the optical space communication in which the laser light is used, the reception device is disposed to face the optical axis of the transmitted laser light to receive light. However, a positional relationship between the optical axis and the reception device may change from moment to moment due to disturbances such as vibration of the device or atmospheric disturbance.

For example, Non Patent Literature 1 discloses a method of using a positional deviation detection element such as a CCD image sensor (CCD) or a four-quadrant photodiode (QD) in addition to an APD that receives a signal in order to prevent a reception device from being unable to receive light due to disturbance.

Non Patent Literature 2 discloses a technology of receiving an intensity-modulated transmission beam by a QD and performing optical aberration correction.

### CITATION LIST

### Non Patent Literature

Non Patent Literature 1: Yoshinori Arimoto, “Design of Ultra-Small Optical Communication Apparatus Suitable for Short-Range Inter-Satellite Relay and Performance Evaluation on the Ground,” Journal of The Institute of Electronics, Information and Communication Engineers B Vol. J91-B No. 12, December 2008, pp. 1561-1568
Non Patent Literature 2: Kenichi Araki and five others, “Development of Basic Experimental Apparatus for Optical Communication,” Review of the Communications Research Laboratory, Vol. 40 No. 2, June 1994, pp. 153-179

### SUMMARY OF INVENTION

### Technical Problem

However, in the related art, when a main signal cannot be received by an APD, a control signal cannot be received at the same time. If the main signal is lost, the lost signal can be compensated for by performing retransmission. On the other hand, if the control signal is lost, there is a possibility of maintenance of communication failing. Accordingly, the control signal is required to avoid a loss more than the main signal.

The present invention has been made in view of the above-described problems, and an objective of the present invention is to provide an optical space communication device and an optical space communication method capable of reducing a loss of a control signal even when a main signal is lost due to positional deviation of an optical axis.

### Solution to Problem

According to an embodiment of the present invention, an optical space communication device includes: an optical antenna configured to receive laser light emitted by multiplexing a main signal to be communicated and a control signal used to maintain or control the communication; an optical branching element configured to branch the laser light received by the optical antenna into first laser light and second laser light; a main signal extraction unit configured to extract the main signal based on the first laser light; a positional deviation detection unit configured to detect a positional deviation of the laser light based on the second laser light; and a control signal extraction unit configured to extract the control signal based on the second laser light.

According to another embodiment of the present invention, an optical space communication method includes: a reception step of receiving laser light emitted by multiplexing a main signal to be communicated and a control signal used to maintain or control the communication; an optical branching step of branching the received laser light into first laser light and second laser light; a main signal extraction step of extracting the main signal based on the first laser light; a positional deviation detection step of detecting a positional deviation of the laser light based on the second laser light; and a control signal extraction step of extracting the control signal based on the second laser light.

### Advantageous Effects of Invention

According to the present invention, it is possible to reduce a loss of a control signal even when a main signal is lost due to positional deviation of an optical axis.

### BRIEF DESCRIPTION OF DRAWINGS

FIG. 1 is a diagram illustrating a configuration example of an optical space communication device according to an embodiment.

FIG. 2 is a diagram illustrating a specific configuration example of a second light reception element and a control signal extraction unit.

FIG. 3 is a diagram illustrating a specific configuration of a modification of the second light reception element and the control signal extraction unit.

FIG. 4 is a diagram illustrating a configuration of a modification of the optical space communication device according to the embodiment.

FIG. 5 is a diagram illustrating an overview of an optical space communication system that performs optical space communication in which laser light is used.

FIG. 6 is a diagram illustrating a configuration of an optical space communication device according to a comparative example.

FIG. 7 is a diagram illustrating an image example indicating a result output by a CCD.

FIG. 8 is a diagram illustrating a configuration example of a QD.

### DESCRIPTION OF EMBODIMENTS

Before an optical space communication device according to an embodiment is described, the background of the present invention will be specifically described first.

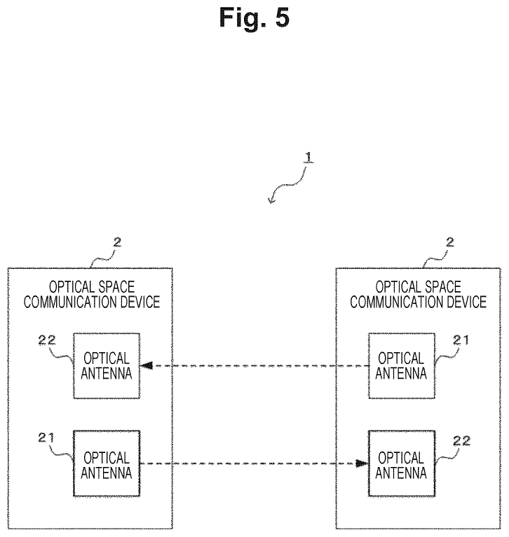

FIG. 5 is a diagram illustrating an overview of an optical space communication system 1 that performs optical space communication in which laser light is used. As illustrated in FIG. 5, in the optical space communication system 1, for example, two optical space communication devices 2 perform bidirectional space communication in which spatial light such as laser light is used.

Each of the optical space communication devices 2 includes an optical antenna 21 for transmission and an optical antenna 22 for reception and has a function as an optical space transmission device and a function as an optical space reception device. The optical space communication device 2 may be configured to have only either a function as an optical space transmission device or a function as an optical space reception device.

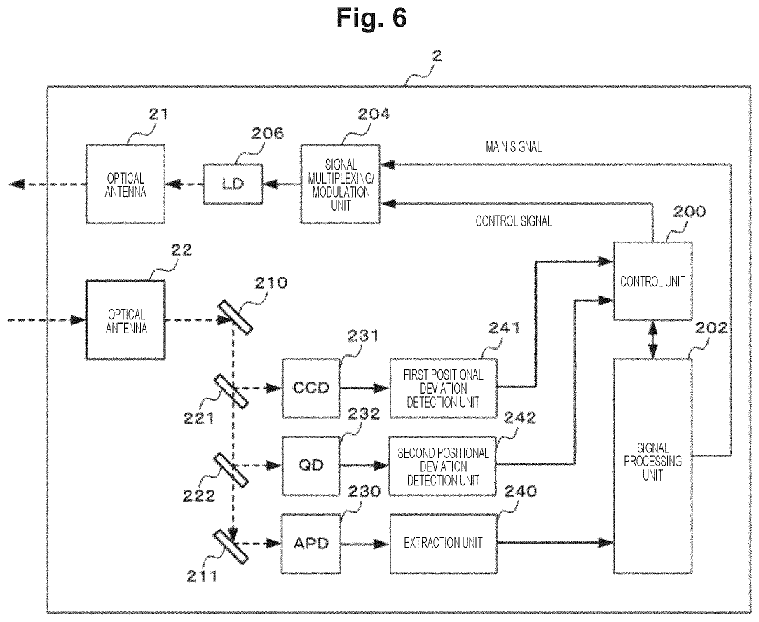

FIG. 6 is a diagram illustrating a configuration of an optical space communication device 2 according to a comparative example. As illustrated in FIG. 6, the optical space communication device 2 according to the comparative example includes a control unit 200, a signal processing unit 202, a signal multiplexing/modulation unit 204, a laser light source (laser diode (LD)) 206, an optical antenna 21, an optical antenna 22, reflection mirrors 210 and 211, beam splitters 221 and 222, an APD 230, a CCD 231, a QD 232, an extraction unit 240, a first positional deviation detection unit 241, and a second positional deviation detection unit 242.

The control unit 200 controls each unit included in the optical space communication device 2. For example, the control unit 200 generates a control signal including an instruction, a device information notification, and the like used to maintain or control communication when the optical space communication device 2 performs optical space communication in which laser light is used with another optical space communication device 2, and outputs the control signal to the signal multiplexing/modulation unit 204.

The signal processing unit 202 performs predetermined signal processing under the control of the control unit 200. For example, the signal processing unit 202 generates a main signal which is a target (main purpose) of optical space communication in which laser light is used, and outputs the main signal to the signal multiplexing/modulation unit 204.

The signal multiplexing/modulation unit 204 modulates and multiplexes the control signal output from the control unit 200 and the main signal output from the signal processing unit 202 in conformity with different modulation schemes, respectively, and outputs a multiplexed signal to the laser light source 206.

The laser light source 206 is driven with the signal output from the signal multiplexing/modulation unit 204 to generate laser light modulated at a predetermined modulation frequency, for example, and output the laser light to the optical antenna 21.

The optical antenna 21 forms an image of the laser light output from the laser light source 206 with, for example, diffraction limit accuracy, shapes the laser light to be appropriate for optical space communication, and emits the laser light to a space toward the optical antenna 22 included in the other optical space communication device 2. That is, the optical antenna 21 emits the laser light obtained by multiplexing the main signal to be communicated and the control signal used to maintain or control communication.

The optical antenna 22 receives the laser light emitted from the optical antenna 21 included in the other optical space communication device 2 and outputs the laser light toward the reflection mirror 210.

The reflection mirror 210 reflects the laser light output from the optical antenna 22 toward the reflection mirror 211. The reflection mirror 211 reflects the laser light reflected from the reflection mirror 210 toward the APD 230.

The beam splitters 221 and 222 are disposed between the reflection mirrors 210 and 211. The beam splitters 221 and 222 are optical branching elements that branch the laser light reflected from the reflection mirror 210 to the reflection mirror 211.

Specifically, the beam splitter 221 reflects a part of the laser light reflected from the reflection mirror 210 toward the CCD 231, and transmits the remaining laser light toward the reflection mirror 211. The beam splitter 222 reflects a part of the laser light transmitted by the beam splitter 221 toward the QD 232 and transmits the remaining laser light toward the reflection mirror 211.

The APD 230 is a light reception element that receives the laser light reflected from the reflection mirror 211, performs photoelectric conversion, and outputs a signal to the extraction unit 240.

The extraction unit 240 separates and extracts the control signal and the main signal from the signal photoelectrically converted by the APD 230, and outputs the extracted control signal and main signal to the signal processing unit 202.

The CCD 231 is a light reception element in which a plurality of pixels are arranged on a wider 2-dimensional light reception surface than the APD 230, receives the laser light reflected by the beam splitter 221, performs photoelectric conversion on each pixel, and outputs a signal to the first positional deviation detection unit 241.

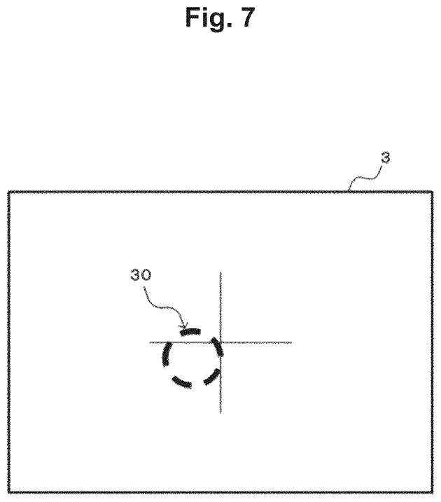

FIG. 7 is an image example illustrating a result output from CCD 231. As illustrated in FIG. 7, the CCD 231 outputs, as a pixel value, a position and brightness of a bright spot 30 generated by the laser light in an imaging region 3 corresponding to the light reception surface.

The first positional deviation detection unit 241 (see FIG. 6) extracts the bright spot 30 through image processing based on the signal (pixel value) output from the CCD 231, detects a positional deviation of an optical axis of the laser light, and outputs a detection result to the control unit 200.

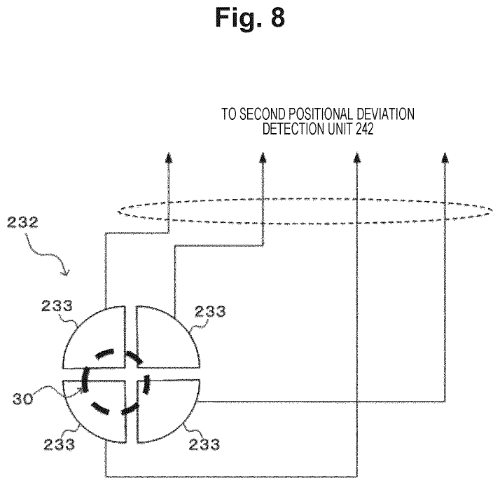

As exemplified in FIG. 8, the QD 232 is, for example, a four-divided photodiode (light reception element) that has four divided light reception surfaces 233 which form a divided circular light reception surface. The light reception surface of the QD 232 is wider than the light reception surface of the APD 230. The divided light reception surfaces 233 of the QD 232 receive the laser light reflected by the beam splitter 222, and output signals obtained through photoelectric conversion to the second positional deviation detection unit 242 for each divided light reception surface 233.

The second positional deviation detection unit 242 extracts the bright spot 30 (see FIG. 8) based on each signal output from the QD 232, detects a positional deviation of the optical axis of the laser light, and outputs the detection result to the control unit 200.

Then, the control unit 200 controls each unit of an optical system in the optical space communication device 2 such that the positional deviation of the optical axis of the laser light is corrected based on the result detected by the first positional deviation detection unit 241 and the result detected by the second positional deviation detection unit 242.

In general, the light reception surface of the CCD or the QD is wider than the light reception surface of the APD. That is, even when the position of the optical axis deviates from the center of the light reception surface, the CCD or the QD can easily capture the optical axis more easily than the APD and receive the light. However, since a response speed of the CCD or the QD is lower than that of the APD, the CCD or the QD is not appropriate for high-speed signal transmission.

On the other hand, responsiveness of the APD is more excellent than that of the CCD or QD. However, since the light reception surface is smaller than the CCD or the QD, the APD may not be able to receive the light due to a slight deviation in the optical axis.

When an optical space communication device of the related art does not include a dedicated communication device receiving the control signal, the optical space communication device of the related art receives a control signal related to communication maintenance such as an instruction to the device or a device information notification by using a part of the main signal. That is, both the main signal and the control signal may be lost due to a slight deviation in the optical axis.

Accordingly, the optical space communication device according to the embodiment is configured to be able to reduce a loss of the control signal even when the main signal is lost due to a positional deviation of the optical axis.

Next, a configuration example of the optical space communication device according to the embodiment will be described. Hereinafter, in the optical space communication device according to the embodiment, substantially the same components as those described above are denoted by the same reference numerals.

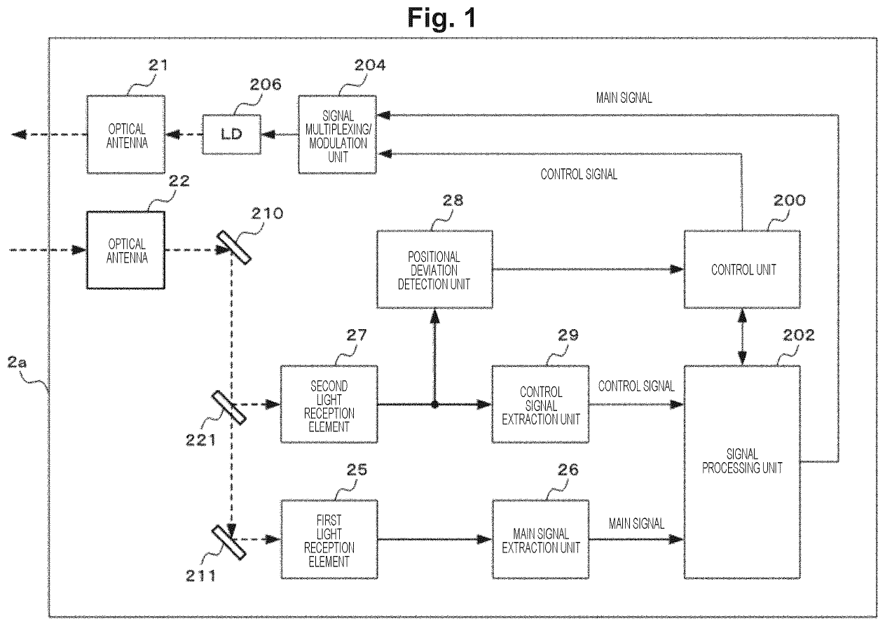

FIG. 1 is a diagram illustrating a configuration example of the optical space communication device 2a according to an embodiment. As illustrated in FIG. 1, the optical space communication device 2a includes a control unit 200, a signal processing unit 202, a signal multiplexing/modulation unit 204, a laser light source 206, an optical antenna 21, an optical antenna 22, reflection mirrors 210 and 211, a beam splitter 221, a first light reception element 25, a main signal extraction unit 26, a second light reception element 27, a positional deviation detection unit 28, and a control signal extraction unit 29.

In the optical space communication device 2a, the beam splitter 221 splits the intensity-modulated laser light received by the optical antenna 22, for example, by causing a part of the laser light to be transmitted as first laser light, and causes the remaining laser light received by the optical antenna 22 to be reflected as second laser light.

In the laser light received by the optical antenna 22, a control signal is superimposed on a main signal. For example, it is assumed that a modulation depth of the control signal is shallow so that there is no influence on the reception of the main signal in the APD that receives the laser light. A modulation frequency of the control signal is set to be low enough to be received by a light reception element for detecting a positional deviation of an optical axis that receives the laser light.

The first light reception element 25 is, for example, an APD or the like, receives the laser light (first laser light) reflected from the reflection mirror 211, performs photoelectric conversion, and outputs a signal to the main signal extraction unit 26.

The main signal extraction unit 26 extracts the main signal from the signal photoelectrically converted by the first light reception element 25 and outputs the extracted main signal to the signal processing unit 202. That is, the main signal extraction unit 26 extracts the main signal based on the first laser light.

The second light reception element 27 is, for example, a CCD or a QD that has a wider 2-dimensional light reception surface than the first light reception element 25. The second light reception element 27 receives the laser light (second laser light) reflected by the beam splitter 221, performs photoelectric conversion, and outputs a signal to each of the positional deviation detection unit 28 and the control signal extraction unit 29.

The positional deviation detection unit 28 detects a positional deviation of the optical axis of the laser light based on the signal output from the second light reception element 27, and outputs a detection result to the control unit 200. That is, the positional deviation detection unit 28 detects the positional deviation of the laser light based on the second laser light.

The control signal extraction unit 29 extracts the control signal from the signal photoelectrically converted by the second light reception element 27, and outputs the extracted control signal to the signal processing unit 202. That is, the control signal extraction unit 29 extracts the control signal based on the second laser light.

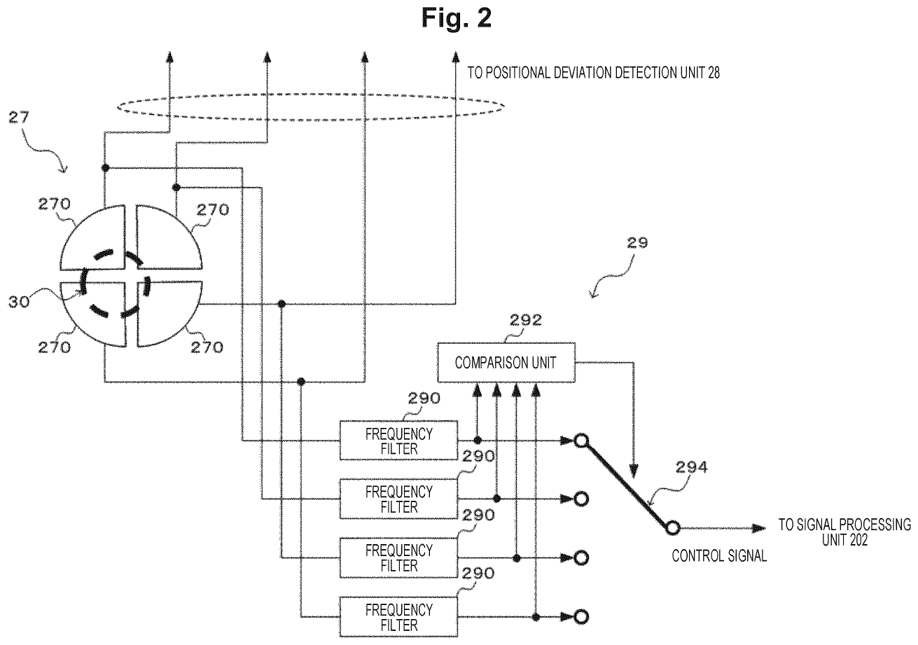

Next, specific configuration examples of the second light reception element 27 and the control signal extraction unit 29 will be described. FIG. 2 is a diagram illustrating a specific configuration example of the second light reception element 27 and the control signal extraction unit 29.

As illustrated in FIG. 2, the second light reception element 27 is, for example, a four-divided photodiode (QD) that has four divided light reception surfaces 270 which form a divided circular light reception surface. The light reception surface of the second light reception element 27 is wider than the light reception surface of the first light reception element 25.

In the second light reception element 27, the divided light reception surface 270 receives the laser light reflected by the beam splitter 221 and outputs a photoelectrically converted signal to the positional deviation detection unit 28 and the control signal extraction unit 29 for each divided light reception surface 270.

The control signal extraction unit 29 includes, for example, four frequency filters 290, a comparison unit 292, and an output selection switch 294.

When the corresponding divided light reception surface 270 receives the light and the photoelectrically converted signal is input, the four frequency filters 290 pass a signal in a band of the control signal and output the signal to the comparison unit 292 and the output selection switch 294. For example, the frequency filter 290 passes a signal in a band of the intensity-modulated control signal in the signal output from the divided light reception surface 270.

The comparison unit 292 compares the signals output from the frequency filters 290, and drives the output selection switch 294 such that the output selection switch 294 selects the output of the frequency filter 290 of which an output is maximum.

The output selection switch 294 selects the output of the frequency filter 290 of which the output is the maximum in response to driving of the comparison unit 292 and outputs the output as a control signal to the signal processing unit 202.

That is, since the control signal extraction unit 29 extracts the control signal based on the second laser light of which the output received by one of the divided light reception surfaces 270 is maximum, a diversity effect can be obtained.

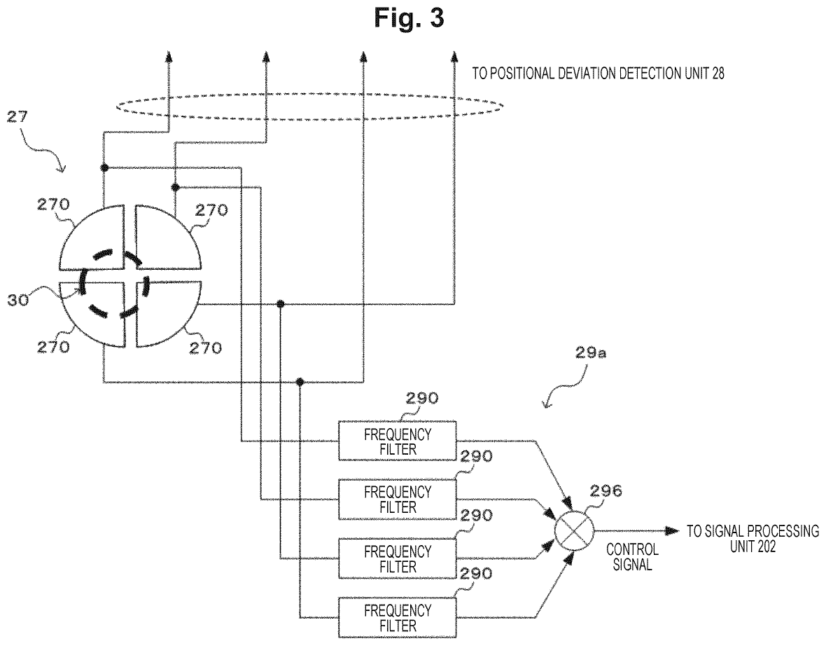

FIG. 3 is a diagram illustrating a specific configuration example of a modification (s control signal extraction unit 29a) of the second light reception element 27 and the control signal extraction unit 29. As illustrated in FIG. 3, the control signal extraction unit 29a includes, for example, four frequency filters 290 and a combination unit 296.

In the control signal extraction unit 29a, when a signal received and photoelectrically converted by the corresponding divided light reception surface 270 is input, the frequency filter 290 passes a signal in a band of the control signal and outputs the signal to the combination unit 296.

The combination unit 296 combines the signals input from the frequency filters 290 and outputs the combined signal as a control signal to the signal processing unit 202. For example, the combination unit 296 may perform any of combination for obtaining a sum of the outputs of the frequency filters 290, equal gain combination for combining phases of the outputs of the frequency filters 290, maximum ratio combination for performing combination after multiplying the weights before the combination, and the like.

In this case, the control signal extraction unit 29a extracts the control signal based on a result of combining the pieces of second laser light received by the divided light reception surfaces 270.

It is considered that the control signal extraction unit 29a outputs substantially the same result as the control signal extraction unit 29 illustrated in FIG. 2 when the laser light is incident on only one of the divided light reception surfaces 270.

However, when the laser light is incident across the plurality of divided light reception surfaces 270, the control signal extraction unit 29a can output the control signal with higher power than the control signal extraction unit 29 illustrated in FIG. 2 due to the combination effect.

The optical space communication device 2a is not limited to the case in which the optical antenna 22 receives the laser light in which the control signal is multiplexed through intensity modulation, and the control signal may be superimposed on the main signal in accordance with another method such as phase modulation.

As described above, the optical space communication device 2a can not only suppress the output fluctuation of the control signal but also receive a larger control signal.

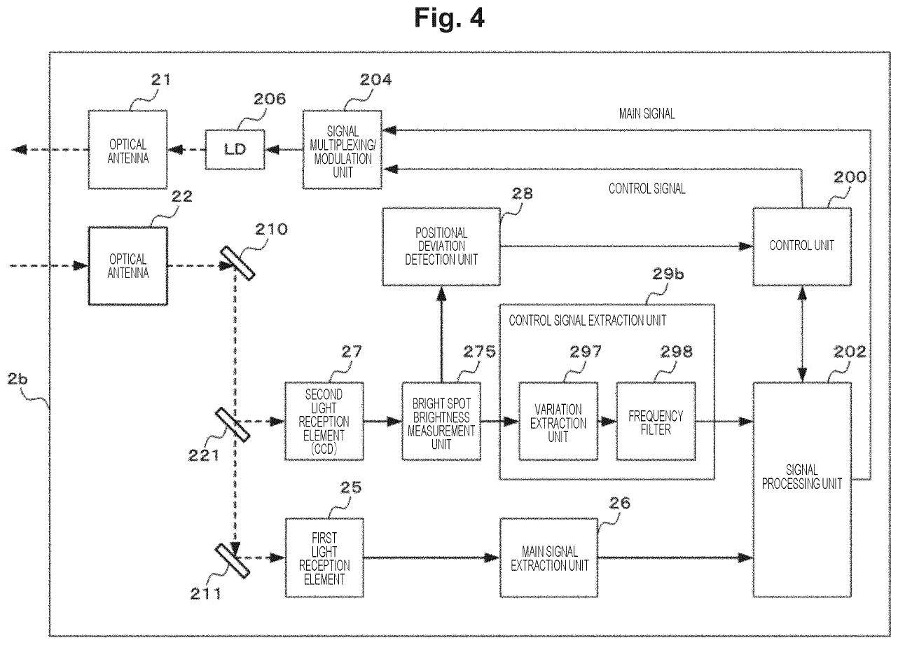

Next, a modification (an optical space communication device 2b) of the optical space communication device 2a according to the embodiment will be described. FIG. 4 is a diagram illustrating a configuration of a modification (the optical space communication device 2b) of the optical space communication device 2a according to the embodiment.

As illustrated in FIG. 4, the optical space communication device 2b includes the control unit 200, the signal processing unit 202, the signal multiplexing/modulation unit 204, the laser light source 206, the optical antenna 21, the optical antenna 22, the reflection mirrors 210 and 211, the beam splitter 221, a first light reception element 25, a main signal extraction unit 26, a second light reception element 27, a bright spot brightness measurement unit 275, a positional deviation detection unit 28, and a control signal extraction unit 29b.

In the optical space communication device 2b, the optical antenna 22 receives intensity-modulated laser light. The second light reception element 27 is, for example, a CCD. In this case, the second light reception element 27 can output the brightness of the bright spot for each pixel disposed on the light reception surface.

The bright spot brightness measurement unit 275 measures the brightness of the bright spot output from the second light reception element 27, and outputs a measurement result to each of the positional deviation detection unit 28 and the control signal extraction unit 29b.

The positional deviation detection unit 28 detects a positional deviation of the optical axis of the laser light based on the brightness of the bright spot output by the bright spot brightness measurement unit 275, and outputs a detection result to the control unit 200. That is, the positional deviation detection unit 28 detects the positional deviation of the laser light based on the second laser light.

The control signal extraction unit 29b includes a variation extraction unit 297 and a frequency filter 298. The variation extraction unit 297 extracts a temporal variation of the brightness of the bright spot output from the second light reception element 27 and measured by the bright spot brightness measurement unit 275 and outputs the temporal variation to the frequency filter 298. When the temporal variation of the brightness of the bright spot output by the variation extraction unit 297 (that is, a frequency of the brightness of the bright spot) is in the frequency band of the control signal, the frequency filter 298 extracts the control signal by passing the signal and outputs the control signal to the signal processing unit 202.

In this way, the optical space communication device 2b extracts the bright spot position from the image captured by the second light reception element 27 such as a CCD, measures the temporal variation of the brightness of the bright spot, and extracts the control signal using the frequency filter 298.

The temporal variation of the brightness of the bright spot is the temporal variation of the signal intensity. That is, the second light reception element 27 such as a CCD receives the intensity-modulated control signal. Each piece of information output from the second light reception element 27 can also be processed using software. That is, the optical space communication device 2b can have a configuration in which the number of pieces of hardware is reduced.

As described above, in the optical space communication devices 2a and 2b according to the embodiment, the light reception surface of the second light reception element 27 is larger than the light reception surface of the first light reception element 25. Therefore, even when the position of the optical axis of the received laser light deviates to deviate from the light reception surface of the first light reception element 25, there is a high likelihood of the second light reception element 27 being able to receive the laser light. When the optical space communication devices 2a and 2b are not separate from a communication device that receives only the control signal and the main signal is lost due to the positional deviation of the optical axis, the loss of the control signal cam be reduced.

### REFERENCE SIGNS LIST

1 Optical space communication system
2, 2a, 2b Optical space communication device
21 Optical antenna
22 Optical antenna
25 First light reception element
26 Main signal extraction unit
27 Second light reception element
28 Positional deviation detection unit
29, 29a, 29b Control signal extraction unit
30 Bright spot
200 Control unit
202 Signal processing unit
204 Signal multiplexing/modulation unit
206 Laser light source
210, 211 Reflection mirror
221 Beam splitter
270 Divided light reception surface
275 Bright spot brightness measurement unit
290 Frequency filter
292 Comparison unit
294 Output selection switch
296 Combination unit
297 Variation extraction unit
298 Frequency filter

1. An optical space communication device including:
an optical antenna to receive laser light emitted by multiplexing a main signal to be communicated and a control signal used to maintain or control the communication;
an optical branching element to branch the laser light received by the optical antenna into first laser light and second laser light;
main signal extraction circuitry configured to extract the main signal based on the first laser light;
a positional deviation detector to detect a positional deviation of the laser light based on the second laser light; and
control signal extraction circuitry configured to extract the control signal based on the second laser light.

2. The optical space communication device according to claim 1, further comprising:
a first light reception element configured to receive the first laser light; and
a second light reception element configured to receive the second laser light on a wider light reception surface than the first light reception element,
wherein the positional deviation detector detects a positional deviation of the laser light based on the second laser light received by the second light reception element; and
the control signal extraction circuitry extracts the control signal based on the second laser light received by the second light reception element.

3. The optical space communication device according to claim 2,
wherein the second light reception element includes a plurality of divided light reception surfaces which form a divided light reception surface,
wherein the control signal extraction circuitry extracts the control signal based on the second laser light of which an output received by one of the divided light reception surfaces is a maximum.

4. The optical space communication device according to claim 2,
wherein the second light reception element includes a plurality of divided light reception surfaces which form a divided light reception surface, and
wherein the control signal extraction circuitry extracts the control signal based on a result obtained by combining the pieces of second laser light received by the divided light reception surfaces.

5. The optical space communication device according to claim 2,
wherein the second light reception element outputs brightness of a bright spot for each of pixels arranged on the light reception surface;
wherein the control signal extraction circuitry extracts the control signal based on a temporal variation of the brightness of the bright spot output from the second light reception element.

6. An optical space communication method, comprising:
receiving laser light emitted by multiplexing a main signal to be communicated and a control signal used to maintain or control the communication;
branching the received laser light into first laser light and second laser light;
extracting the main signal based on the first laser light;
detecting a positional deviation of the laser light based on the second laser light; and
extracting the control signal based on the second laser light.

7. The optical space communication method according to claim 6,
wherein, in the detecting the positional deviation, the positional deviation of the laser light is detected based on the second laser light received by a second light reception element that receives the second laser light on a wider light reception surface than a first light reception element that receives the first laser light; and
wherein, in the extracting, the control signal is extracted based on the second laser light received by the second light reception element.
